(19) United States
(12) Patent Application Publication
(10) Pub. No.: US 2013/0267219 A1
(43) Pub. Date: Oct. 10, 2013

(54) MOBILE TERMINAL AND CONTROL METHOD FOR ELECTRONIC APPARATUS OPERATION USING THE MOBILE TERMINAL

(71) Applicants: Hiraku Ito, Osaka (JP); Satoshi Inami, Osaka (JP)

(72) Inventors: Hiraku Ito, Osaka (JP); Satoshi Inami, Osaka (JP)

(21) Appl. No.: 13/809,438

(22) PCT Filed: May 16, 2012
(86) PCT No.: PCT/JP12/03197

§ 371 Date: Jan. 10, 2013

(30) Foreign Application Priority Data
Sep. 20, 2011 (JP) 2011-204852

(51) Int. Cl. H04W 4/00

(52) U.S. Cl. CPC H04W 4/001
USPC 455/420

(57) ABSTRACT

A mobile terminal periodically confirms the state of a takeover permission terminal (another mobile terminal) registered in takeover permission terminal information (S801). At this time, the mobile terminal determines whether or not a specific event (incoming call, power-off, etc.) has occurred on the takeover permission terminal (S802). If the mobile terminal has determined that a specific event has occurred on the takeover permission terminal, the mobile terminal confirms whether or not the mobile terminal is registered in the takeover side terminal information of the takeover permission terminal (S803). Then, if the mobile terminal is registered, the mobile terminal takes over the operation that the takeover permission terminal has performed (S804).

### TECHNICAL FIELD

The present invention relates to a mobile terminal and a control method for electronic apparatus operation using the mobile terminal, and more specifically to a control method for electronic apparatus operation using a mobile terminal, performed in a system that includes a plurality of mobile terminals connected via a network and performing different operations for the same electronic apparatus.

### BACKGROUND ART

An example of techniques of operating an electronic apparatus such as a television or a video recorder by using a mobile terminal such as a smartphone or a mobile phone is disclosed in Patent Literature 1. FIG. 19 is a diagram showing a schematic configuration of a conventional mobile terminal 510 disclosed in Patent Literature 1.

In FIG. 19, the conventional mobile terminal 510 has a communication control section 511 and an electronic apparatus operation section 512 which are connected to a bus 516. When the communication control section 511 has detected incoming call to the mobile terminal 510, the electronic apparatus operation section 512 generates a control signal for instruction of turning the power on or off, stopping a function being executed, or the like, and transmits the control signal to an electronic apparatus via the communication control section 511. Thus, the conventional mobile terminal 510 controls the operation for an electronic apparatus as a control target, in accordance with incoming call to the mobile terminal 510.

### CITATION LIST

### Patent Literature

[PTL 1] Japanese Laid-Open Patent Publication No. 2002-27142

### SUMMARY OF THE INVENTION

### Problems to be Solved by the Invention

The technique disclosed in Patent Literature 1 controls a plurality of electronic apparatuses by one mobile terminal. On the other hand, a method for controlling one electronic apparatus by a plurality of mobile terminals is also conceivable. In this case, a problem is how to control the single electronic apparatus by each mobile terminal.

Therefore, an object of the present invention is to provide a method for appropriately controlling one electronic apparatus by a plurality of mobile terminals, and such a mobile terminal.

### Solution to the Problems

The present invention is directed to a mobile terminal in a system that includes a plurality of mobile terminals connected via a network and performing different operations for the same electronic apparatus, and to a control method for electronic apparatus operation using such a mobile terminal in the system.

In order to achieve the above object, a mobile terminal of the present invention includes: a communication control section configured to control wireless communication with another mobile terminal other than the mobile terminal, and with an electronic apparatus; an electronic apparatus operation section configured to operate the electronic apparatus via the communication control section; a storage section configured to store takeover information about the other mobile terminals, the takeover information having registered therein a takeover target for the operation for the electronic apparatus; and a takeover side control section configured to monitor the state of another mobile terminal registered as the takeover target in the takeover information, and take over, from another mobile terminal for which it has been determined that a specific event has occurred, an operation that the other mobile terminal has performed for the electronic apparatus.

### Advantageous Effects of the Invention

According to the present invention, even if the state of a specific mobile terminal has changed so that it has become difficult to continue the operation for an electronic apparatus, it is possible to cause a takeover side terminal registered in advance to take over the operation that the specific mobile terminal has been performing.

### BRIEF DESCRIPTION OF THE DRAWINGS

FIG. 1 is a diagram showing a configuration example of an electronic apparatus control system 1 to which a mobile terminal provided by the present invention is applied.

FIG. 2 is a diagram showing the configuration of a mobile terminal 10 according to the first embodiment of the present invention.

FIG. 3A is a diagram showing an example of self terminal information 151 stored in a storage section 15.

FIG. 3B is a diagram showing an example of takeover side terminal information 153 stored in the storage section 15.

FIG. 3C is a diagram showing an example of takeover permission terminal information 154 stored in the storage section 15.

FIG. 4 is a flowchart showing a process of the mobile terminal 10 according to the first embodiment constructing the takeover side terminal information 153.

FIG. 5 is a flowchart showing a process of the mobile terminal 10 according to the first embodiment constructing the takeover permission terminal information 154.

FIG. 6 is a sequence diagram showing a specific process example in the case where a terminal A requests the terminal B to permit registration as a takeover side terminal.

FIG. 7 is a sequence diagram showing a specific process example in the case where the terminal A confirms the states of the terminals B and C registered as takeover permission terminals.

FIG. 8 is a flowchart showing a process of the mobile terminal 10 according to the first embodiment taking over the operation of a takeover permission terminal.

FIG. 9 is a sequence diagram showing a specific process example 1 in the case where the terminal B takes over the operation of the terminal A when a specific event has occurred on the terminal A.

FIG. 10 is a sequence diagram showing a specific process example 2 in the case where, when the event that occurred on the terminal A shown in FIG. 9 has finished, the operation taken over by the terminal B is returned to the terminal A.

FIG. 11 is a sequence diagram showing a specific process example 3 in the case where, when a specific event has occurred on the terminal A, the terminal B takes over the operation of the terminal A.

FIG. 12 is a sequence diagram showing a specific process example 4 in the case where, when the event that occurred on the terminal A shown in FIG. 11 has finished, the operation taken over by the terminal B is returned to the terminal A.

FIG. 13 is a diagram showing the configuration of a mobile terminal 10 according to the second embodiment of the present invention.

FIG. 14 is a diagram showing an example of takeover side terminal information 153 and takeover priority information 255 stored in a storage section 25.

FIG. 15 is a flowchart showing a process of the mobile terminal 10 according to the second embodiment taking over the operation of a takeover permission terminal.

FIG. 16 is a diagram showing the configuration of a mobile terminal 10 according to the third embodiment of the present invention.

FIG. 17 is a diagram showing an example of takeover side terminal information 153, takeover priority information 255, and takeover possible/impossible information 356 stored in a storage section 35.

FIG. 18 is a flowchart showing a process of the mobile terminal 10 according to the third embodiment taking over the operation of a takeover permission terminal.

FIG. 19 is a function block diagram for controlling an electronic apparatus, according to a conventional invention.

### DESCRIPTION OF EMBODIMENTS

### Knowledge as a Basis of the Present Invention

The situation where the screen area of one television is divided into a plurality of small screen areas and the plurality of small screen areas are respectively operated by different mobile terminals (users), will be described.

In the situation where the plurality of divided small screen areas (x, y, z, etc.) in the one television are respectively operated by the different mobile terminals (X, Y, Z, etc.), the mobile terminals can respectively use predetermined small screen areas exclusively. In this case, the screen of the electronic apparatus cannot be used effectively. For example, when the state of the mobile terminal X has changed (e.g., phone call has come or power has been turned off), even though the small screen area x exclusively used by the mobile terminal X is left as it is, the mobile terminal Y and the mobile terminal Z cannot perform operation such as ending the small screen area x.

Therefore, when the state of a specific mobile terminal has changed so that it has become difficult to continue the operation for the electronic apparatus (small screen area x), it is desirable that the operation for the electronic apparatus (small screen area x) is taken over by another mobile terminal.

### Method Devised by the Present Inventors

Accordingly, the present inventors have newly devised a method for, when the state of a specific mobile terminal has changed so that it has become difficult to continue the operation for an electronic apparatus, causing another apparatus to take over the operation for the electronic apparatus that the specific mobile terminal has been performing.

Aspects of the present invention based on the newly devised method are as follows.

### Summary of Aspects of the Invention

One aspect of the present invention is a mobile terminal in a system that includes a plurality of mobile terminals connected in a network and performing different operations for the same electronic apparatus, the mobile terminal including: a communication control section configured to control wireless communication with another mobile terminal other than the mobile terminal, and with the electronic apparatus; an electronic apparatus operation section configured to operate the electronic apparatus via the communication control section; a storage section configured to store takeover information about the other mobile terminals, the takeover information having registered therein a takeover target for the operation for the electronic apparatus; and a takeover side control section configured to monitor the state of another mobile terminal registered as the takeover target in the takeover information, and take over, from another mobile terminal tor which it has been determined that a specific event has occurred, an operation that the other mobile terminal has performed for the electronic apparatus.

According the above aspect, even if the state of a specific mobile terminal has changed so that it has become difficult to continue the operation for an electronic apparatus, it is possible to cause a takeover side terminal registered in advance to take over the operation that the specific mobile terminal has been performing.

In another aspect, the takeover side control section, by periodically communicating with another mobile terminal registered as the takeover target in the takeover information, can share the states of the mobile terminals and the takeover information, with the other mobile terminal. In addition, if a plurality of other mobile terminals registered as the takeover targets are stored together with priorities in the takeover information, the takeover side control section, when the priority of the mobile terminal is the highest, can take over, from another mobile terminal for which it has been determined that a specific event has occurred, an operation that the other mobile terminal has performed for the electronic apparatus. In addition, if a plurality of other mobile terminals registered as the takeover targets are stored together with priorities and information indicating whether or not the plurality of other mobile terminals can take over in the takeover information, the takeover side control section, when the priority of the mobile terminal is the highest among the mobile terminals that can take over, can take over, from another mobile terminal for which it has been determined that a specific event has occurred, an operation that the other mobile terminal has performed for the electronic apparatus.

For example, the specific event may be at least one of telephone incoming call and transfer to the outside of the network. If the mobile terminal further includes a power supply management section configured to manage a power supply state, the specific event also includes power-off.

Still another aspect of the present invention is a control method for an electronic apparatus operation using a mobile terminal in a system that includes a plurality of mobile terminals connected in a network and performing different operations for the same electronic apparatus, the control method including the steps of: performing wireless communication among the plurality of mobile terminals, and storing and sharing takeover information having registered therein a takeover target for the operation tor the electronic apparatus; causing each of the plurality of mobile terminals to monitor the state of a mobile terminal registered as the takeover target in the takeover information; and causing, when a specific event has occurred on a first mobile terminal of the plurality of mobile terminals, a second mobile terminal that has registered the first mobile terminal as a takeover target, to take over the operation that the first mobile terminal has performed for the electronic apparatus.

According the above aspect, even if the state of a specific mobile terminal has changed so that it has become difficult to continue the operation for an electronic apparatus, it is possible to cause a takeover side terminal registered in advance to take over the operation that the specific mobile terminal has been performing.

### Detailed Description of Embodiments of the Invention

Hereinafter, embodiments of the present invention will be described with reference to the drawings.

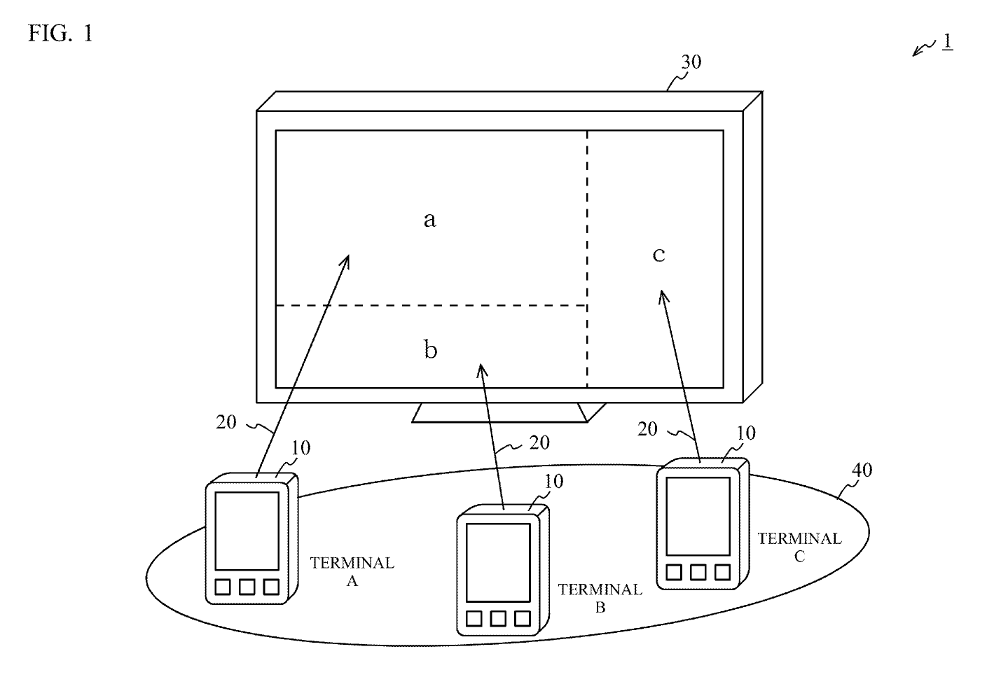

FIG. 1 is a diagram showing a configuration example of an electronic apparatus control system 1 to which a mobile terminal provided by the present invention is applied. The electronic apparatus control system 3 exemplified in FIG. 1 includes a plurality of mobile terminals 10 (terminal A, terminal B, and terminal C) having control function for an electronic apparatus, and an electronic apparatus 30. The plurality of mobile terminals 10 are connected to each other via a local area network 40.

The plurality of mobile terminals 10 are portable wireless communication terminals such as a smartphone or a mobile phone, for example. The electronic apparatus 30 is a display apparatus having a large screen, such as 2K4K television, for example. The plurality of mobile terminals 10 have the same configuration of a mobile terminal described in each embodiment below, and can respectively perform different operations on the display screen of the same electronic apparatus 30 that are arbitrarily divided, by remote control via wireless communication.

In an example shown in FIG. 1, of the plurality of mobile terminals 10, the terminal A performs a predetermined operation (for example, viewing digital terrestrial broadcast) on an area a at the upper left of the screen of the electronic apparatus 30, by wireless communication using a control signal 20. In addition, of the plurality of mobile terminals 10, the terminal B performs a predetermined operation (for example, viewing BS digital broadcast) on an area b at the lower left of the screen of the electronic apparatus 30, by wireless communication using a control signal 20. Further, of the plurality of mobile terminals 10, the terminal C performs a predetermined operation (for example, browsing a web page) on an area c at the right of the screen of the electronic apparatus 30, by wireless communication using a control signal 20.

In the example shown in FIG. 1, the case where three mobile terminals 10 (terminal A, terminal B, and terminal C) are included in the electronic apparatus control system 1 has been described, but the number of the mobile terminals 10 included in the electronic apparatus control system 1 may be other than three as long as a plurality of mobile terminals 30 are included.

In addition, the electronic apparatus 30 may not be a single apparatus such as a television as exemplified in FIG. 1. The electronic apparatus 30 applicable in the present invention is a concept combining an image supplying function section and an image displaying function section. Therefore, a combination of two or more apparatuses composed of an image supplying function section and an image displaying function section that are physically separated, e.g., a combination of a DVD recorder and a television, corresponds to a single electronic apparatus 30.

Hereinafter, embodiments of the plurality of mobile terminals 10 composing the electronic apparatus control system 1 described above will be described in detail.

In the description below, when the plurality of mobile terminals 10 are to be described being clearly distinguished thereamong, they are written as terminal A, terminal B, and terminal C, instead of mobile terminal 10. In addition, when another mobile terminal 10 different from a mobile terminal 10 as a main subject of the description is to be referred to, a suffix x is attached to the reference numeral as “another mobile terminal 10x” so that they are not confused.

### First Embodiment

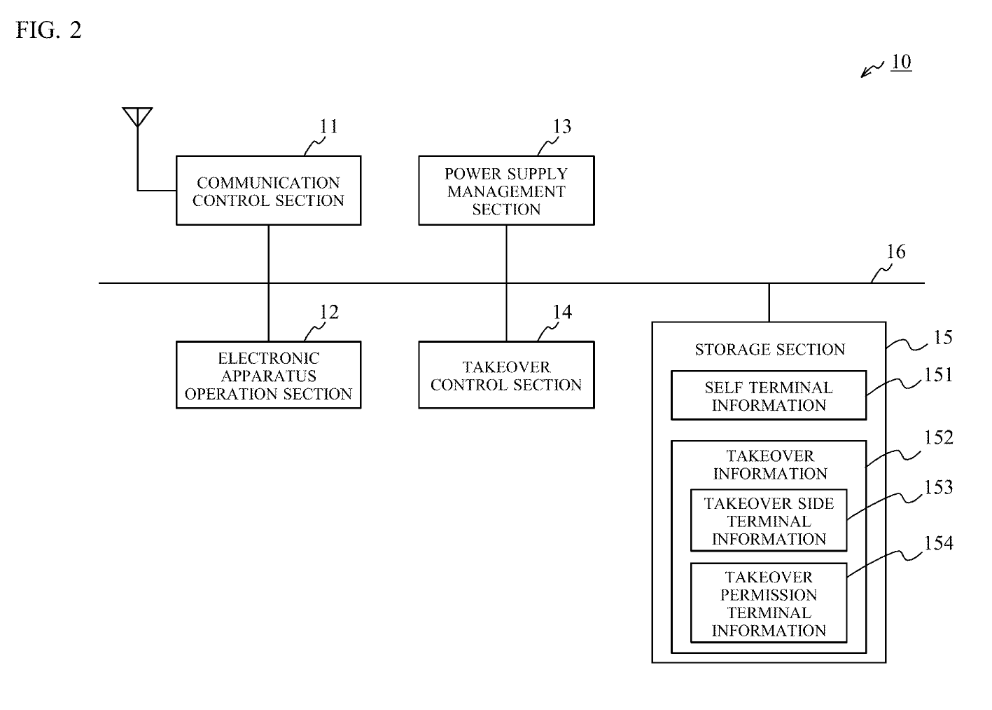

FIG. 2 is a diagram showing the configuration of the mobile terminal 10 according to the first embodiment of the present invention. The mobile terminal 10 according to the first embodiment shown in FIG. 2 includes a communication control section 11, an electronic apparatus operation section 12, a power supply management section 13, a takeover control section 14, and a storage section 15. The communication control section 11, the electronic apparatus operation section 12, the power supply management section 13, the takeover control section 14, and the storage section 15 are electrically connected via a bus 16 so that they can transmit signals to each other.

The communication control section 11 transmits and receives a signal for the mobile terminal 10 to perform wireless communication with another mobile terminal 10x, a base station, a relay station, or the like. In accordance with a user's operation, the electronic apparatus operation section 12 generates a control signal 20 for operating the electronic apparatus 30, and wirelessly transmits the generated control signal 20 to the electronic apparatus 30 via the communication control section 11. The electronic apparatus operation section 12 is, typically, realized by a remote control application (hereinafter, abbreviated as an RC app). The power supply management section 13 manages the state of the power supply of the mobile terminal 10 (for example, remaining charge of a stored battery, or the like). The takeover control section 14 determines and controls another mobile terminal 10x as a takeover side terminal that takes over an operation, and another mobile terminal 10x that is permuted to be taken over. The storage section 15 is, for example, a memory, and stores self terminal information 151 which is information about the mobile terminal 10 that the storage section 15 belongs to, and takeover information 152 which is information about another mobile terminal 10x (takeover target) determined by the takeover control section 14. The takeover information 152 is composed of takeover side terminal information 153 and takeover permission terminal information 154.

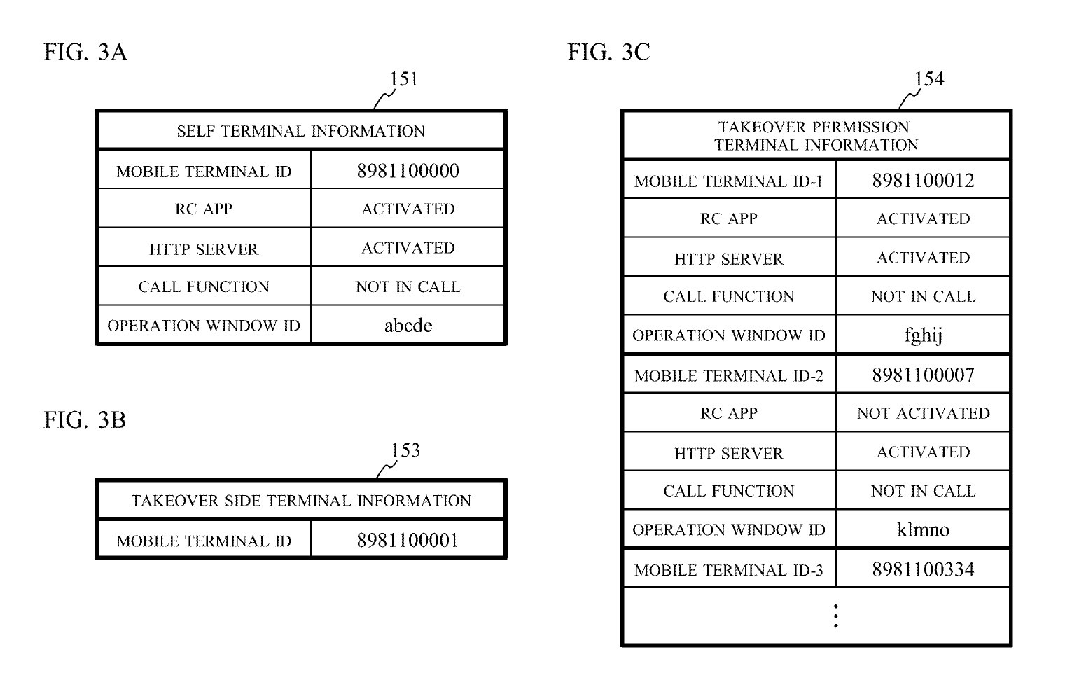

FIG. 3A is a diagram showing an example of the self terminal information 151 stored in the storage section 15 of the first embodiment.

The self terminal information 151 includes a mobile terminal ID, an RC app, an HTTP server, a call function, and an operation window ID. The mobile terminal ID is identification data for uniquely specifying the mobile terminal 10, such as SIM (Subscriber Identity Module) ID, for example. The RC app is information indicating the activation state of an RC app executed by the mobile terminal 10. The HTTP server is information indicating the activation state of an HTTP (Hyper text Transfer Protocol) server used by the mobile terminal 10. The call function is information indicating whether the mobile terminal 10 is using a call function (in a call) or is not using a call function (not in a call). The operation window ID is identification data for uniquely specifying a screen used by the mobile terminal 10, on the arbitrarily divided display screen of the electronic apparatus 30.

FIG. 3B is a diagram showing an example of the takeover side terminal information 153 stored in the storage section 15 of the first embodiment.

The takeover side terminal information 153 includes a mobile terminal ID. The mobile terminal ID of the takeover side terminal information 153 is identification data for uniquely specifying a takeover side terminal, i.e., another mobile terminal 10x that is a takeover target caused to take over the operation of the mobile terminal 10 when a specific event described later has occurred. In the first embodiment, the number of the mobile terminal IDs registered as the takeover side terminal information 153 is one, that is, the number of takeover side terminals is one.

FIG. 3C is a diagram showing an example of the takeover permission terminal information 154 stored in the storage section 15 of the first embodiment.

The takeover permission terminal information 154, similar to the self terminal information 151, includes a mobile terminal ID, an RC app, an HTTP server, a call function, and an operation window ID. The mobile terminal ID of the takeover permission terminal information 154 is identification data for uniquely specifying a takeover permission terminal, i.e., another mobile terminal 10x that is a takeover target permitted to have its operation taken over when a specific event described later has occurred. Information about the takeover permission terminal is registered in the RC app, the HTTP server, the call function, and the operation window ID. As many pieces of data as the number of takeover permission terminals are registered in the takeover permission terminal information 154.

The mobile terminal 10 of the present invention performs takeover control between mobile terminals 10 as shown below, using the takeover information 152 composed of the takeover side terminal information 153 (FIG. 3B) and the takeover permission terminal information 154 (FIG. 3C) described above.

### 1. Construction Method for Takeover Information

First, a process of each of the plurality of mobile terminals 10 constructing its takeover information 152 while communicating with each other, will be described.

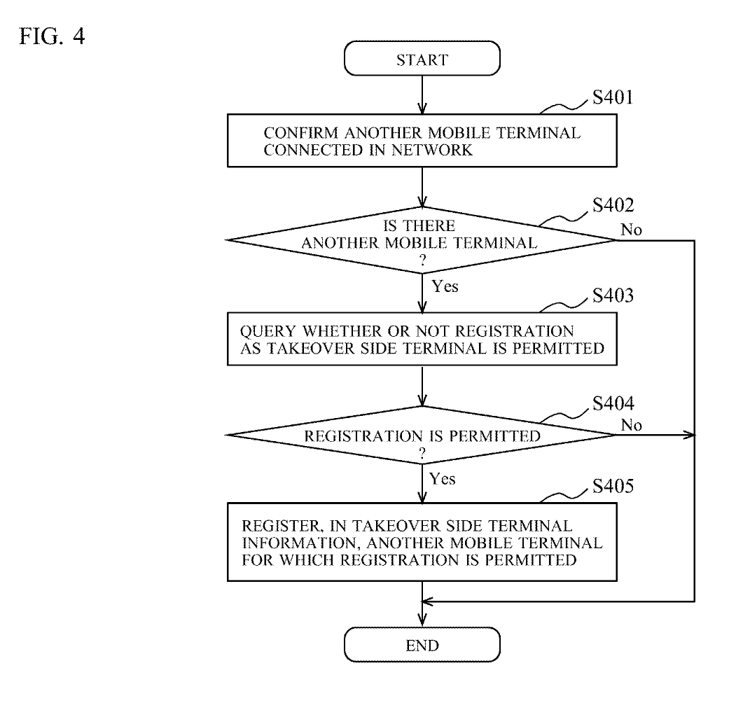

FIG. 4 is a flowchart showing a process of the mobile terminal 10 constructing the takeover side terminal information 153.

The mobile terminal 10 confirms whether or not there is another mobile terminal 10x connected to the local area network 40 (S401). The timing of this confirmation processing is, for example, just after the mobile terminal 10 is powered on or when the mobile terminal 10 is connected to the local area network 40, and in such a timing, the confirmation is performed automatically or by a user's instruction. In addition, it is preferable that the confirmation processing is periodically performed in a predetermined cycle. As a result of the confirmation, if there is such another mobile terminal 10x (S402: Yes), the mobile terminal 10 queries the other mobile terminal 10x whether or not the mobile terminal 10 can register the other mobile terminal 10x as a takeover side terminal (S403). Then, in response to this query, if the mobile terminal 10 has receives a response that permits registration as a takeover side terminal from the other mobile terminal 10x (S404: Yes), the mobile terminal 10 registers the identification data of the other mobile terminal 10x in the mobile terminal ID of the takeover side terminal information 153 (S405). On the other hand, if there is no other mobile terminals 10x (S402: No) or if the mobile terminal 10 cannot receive a response that permits registration as a takeover side terminal from the other mobile terminal 10x (S404: No), the mobile terminal 10 ends the process.

The process shown in FIG. 4 is sequentially performs for all the other mobile terminals 10x confirmed to be present in the confirmation processing in step S401, and one of the mobile terminal IDs of the other mobile terminal 10x determined to be takeover side terminals by the takeover control section 14 is registered in the takeover side terminal information 153.

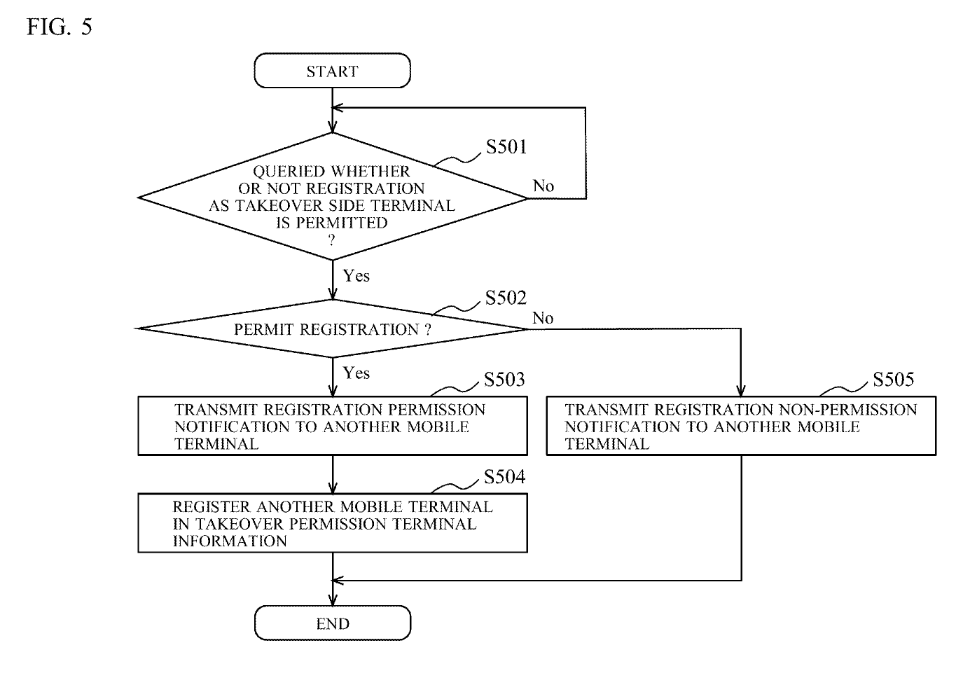

FIG. 5 is a flowchart showing a process of the mobile terminal 10 constructing the takeover permission terminal information 154.

First, the mobile terminal 10 confirms whether or not the mobile terminal 10 has received a query about registration as a takeover side terminal from another mobile terminal 10x connected to the local area network 40 (S501). If the mobile terminal 10 has received such a query (S501: Yes), the mobile terminal 10 determines whether or not to permit registration as a takeover side terminal (S502), and then, if the mobile terminal 10 permits the registration, the mobile terminal 10 transmits a registration permission notification to the other mobile terminal 10x that has queried (S503). Then, its order to register, as a takeover permission terminal, the other mobile terminal 10x to which the registration permission notification has been transmitted, the mobile terminal 10 registers the identification data of the other mobile terminal 10x in the mobile terminal ID of the takeover permission terminal information 154 (S504). On the other hand, if the mobile terminal 10 does not permit the registration, the mobile terminal 10 transmits a registration non-permission notification to the other mobile terminal 10x that has queried (S505). It is noted that if the mobile terminal 10 does not permit registration, the mobile terminal 10 may have the other mobile terminal 10x recognize by itself that the registration is not permitted, by time-out of response waiting time of the other mobile terminal 10x, without transmitting a non-permission notification.

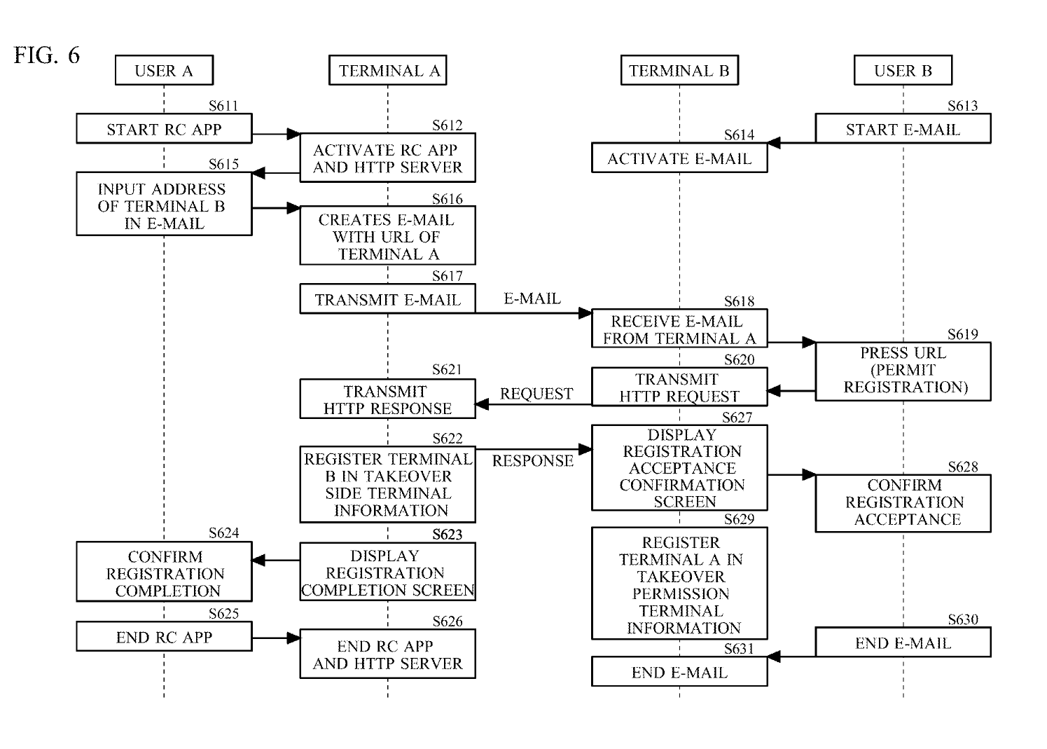

FIG. 6 is a sequence diagram showing a specific process example in the case where the terminal A corresponding to the mobile terminal 10 requests the terminal B corresponding to the other mobile terminal 10x to permit registration as a takeover side terminal in the takeover side terminal information 153.

In accordance with a user A's instruction (S611) to start the RC app, the terminal A activates the RC app and the HTTP server (S612). In accordance with a user B's instruction (S613) to start E-mail, the terminal B activates an E-mail app (S614). After the RC app and the HTTP server are activated, the terminal A creates an E-mail with the URL (Uniform Resource Locator) of the terminal A, for the E-mail address of the terminal B inputted (S615) by the user A, and transmits the E-mail to the terminal B (S616, S617). The terminal B receives the E-mail from the terminal A and presents the E-mail to the user B (S618). If the user B permits the request from the terminal A, the user B executes selection of URL (e.g., press a button) (S619), and transmits an HTTP request to the terminal A (S620). The terminal A transmits an HTTP response to the terminal B in response to the HTTP request (S621) and registers the terminal B as a takeover side terminal in the takeover side terminal information 153 (S622). After completing registration of the terminal B, the terminal A displays a screen indicating the completion of registration, to have the user A confirm the registration content (S623, S624). The user A, after confirming the registration of the terminal B, instructs the terminal A to end the RC app (S625), and the terminal A ends the RC app and the HTTP server (S626). On the other hand, the terminal B displays a registration acceptance confirmation screen (not shown) in accordance with the HTTP response received from the terminal A (S627), and has the user B confirm that the terminal B has been registered as a takeover side terminal by the terminal A (S628). In addition, the terminal B registers the terminal A as a takeover permission, terminal in the takeover permission terminal information 154 (S629). The user B, after confirming the registration of the terminal A, instructs the terminal B to end E-mail (S630), and the terminal B ends the E-mail app (S631).

### 2. Confirmation Processing of Terminal State

Next, a process of the mobile terminal 10 confirming the state of another mobile Terminal 10x registered as a takeover permission terminal, based on the constructed takeover information 152, will be described.

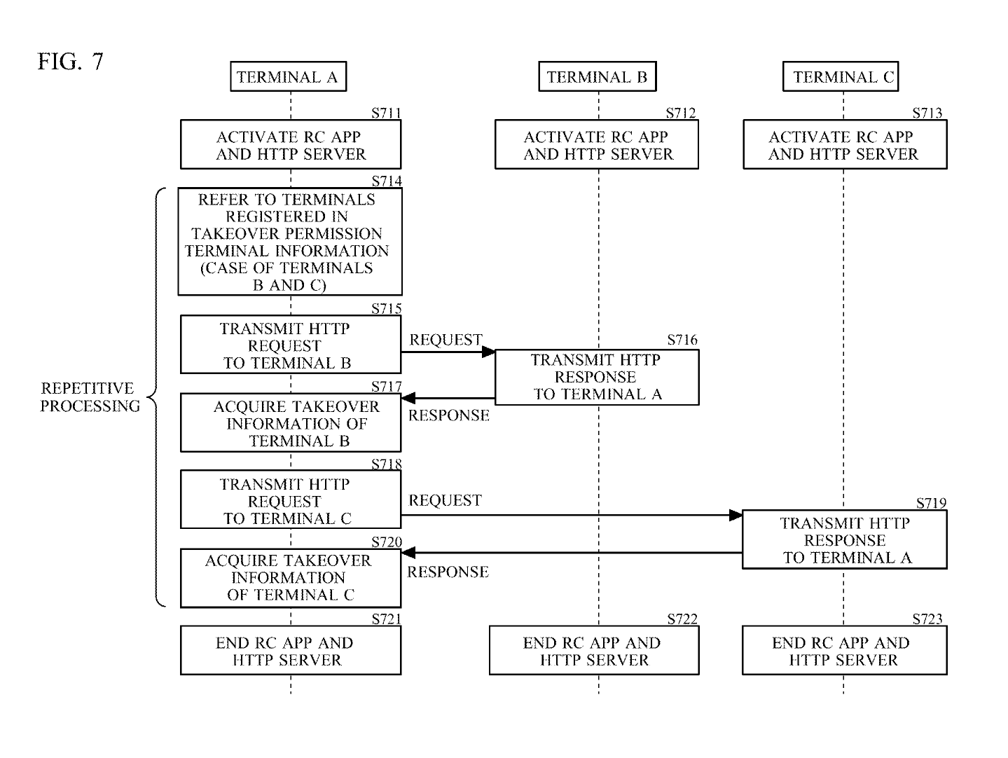

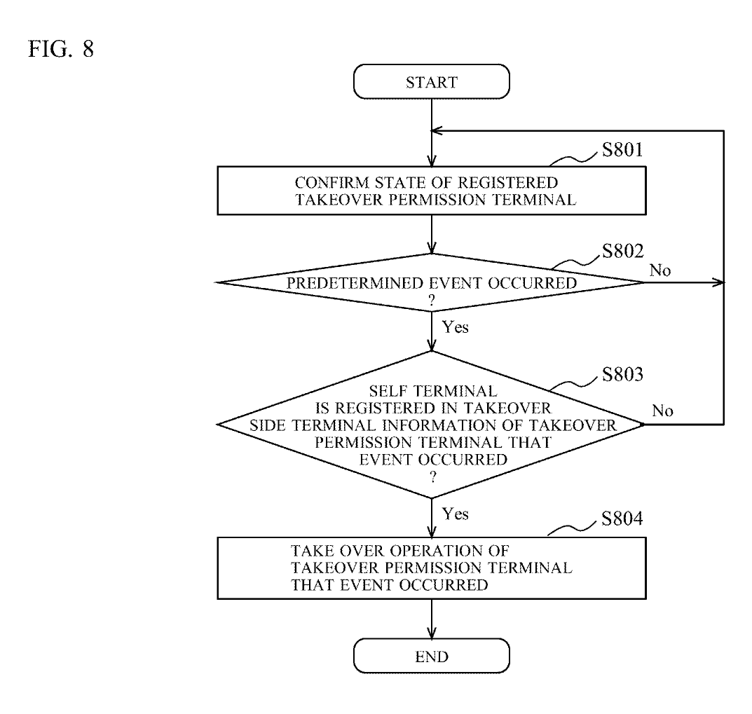

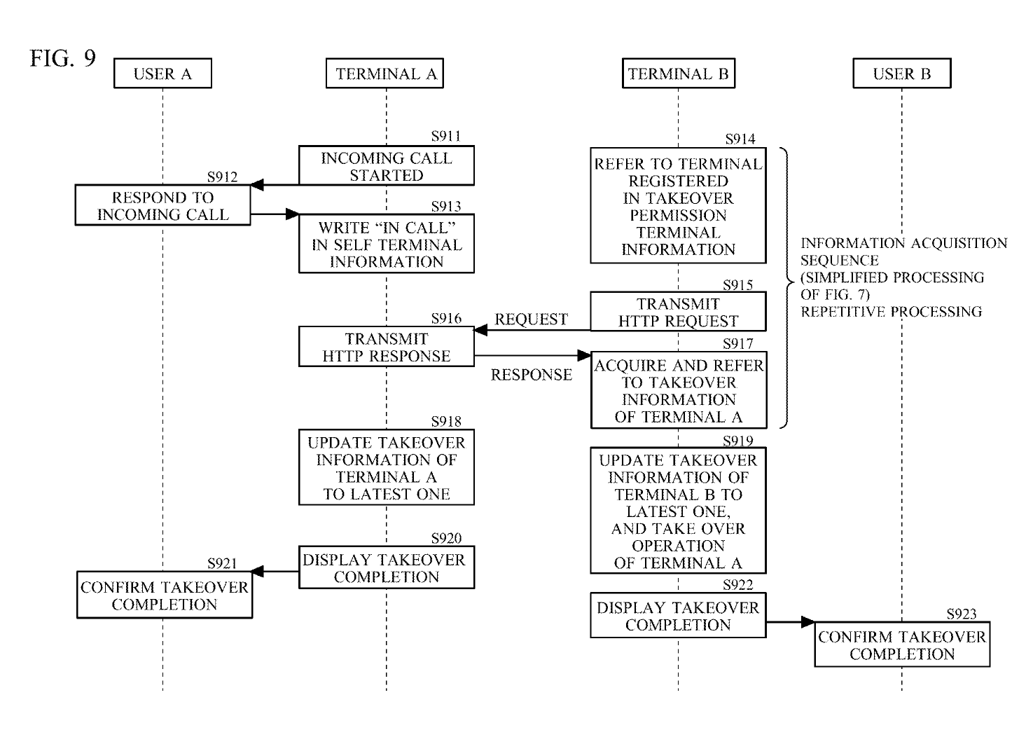

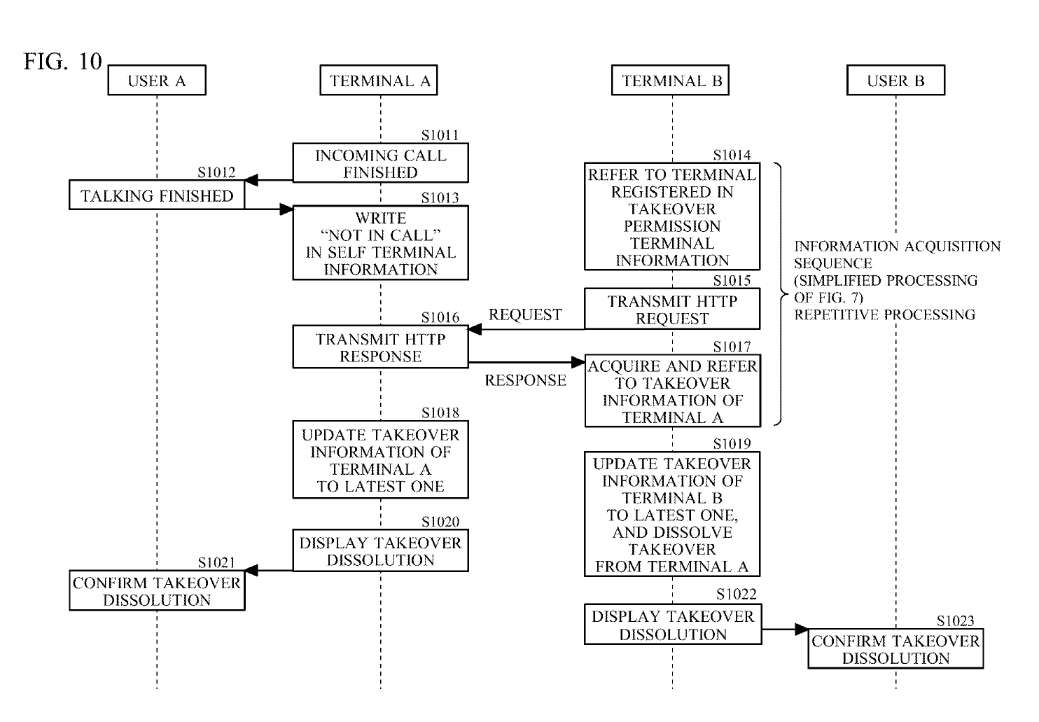

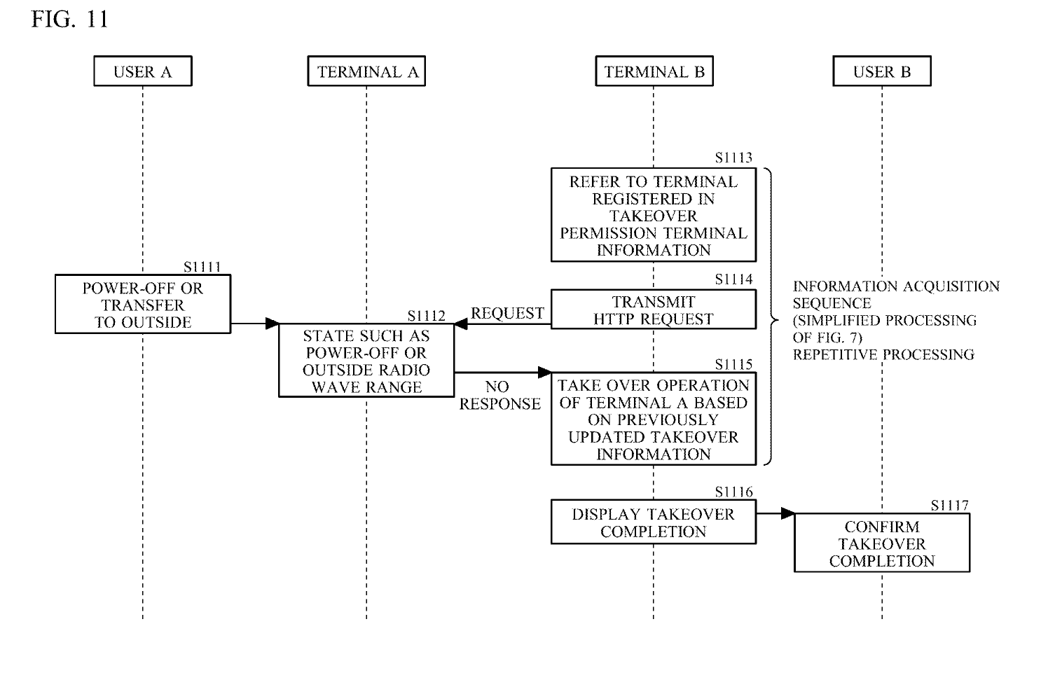

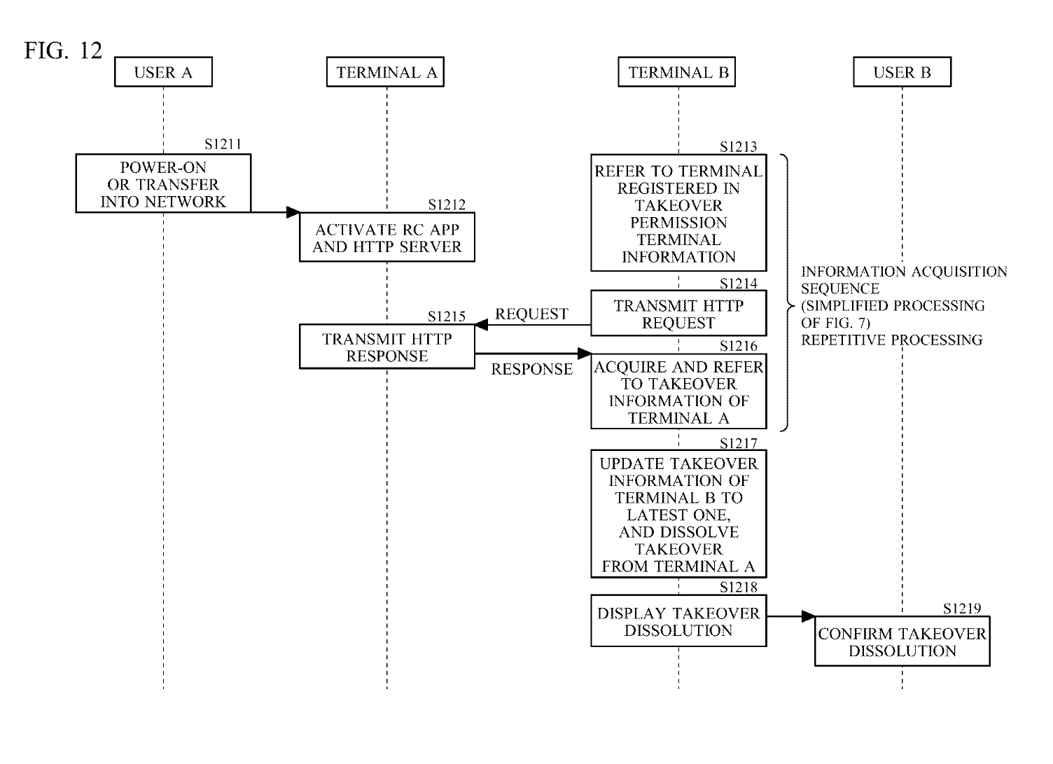

FIG. 7 is a sequence diagram showing a specific process example in the case where the terminal A confirms the states of the terminals B and C registered as takeover permission terminals in the takeover permission terminal information 154.

It will be assumed that the terminal A, the terminal B, and the terminal C each have activated the RC app and the HTTP server (S711 to S713). The terminal A refers to the takeover permission terminal information 154 of the takeover information 152 (S714), to perform acquisition processing of the takeover information 152 of the takeover permission terminals that are registered. In an example shown in FIG. 7, the terminal 8 and the terminal C are both registered in the takeover permission terminal information 154 of the terminal A. In this case, the terminal A transmits an HTTP request to the terminal B (S715), and receives an HTTP response with the takeover information 152 from the terminal B (S716). Thus, the terminal A acquires the takeover information 152 of the terminal B (S717). Similarly, the terminal A transmits an HTTP request to the terminal C (S718), and receives an HTTP response with the takeover information 152 from the terminal C (S719). Thus, the terminal A acquires the takeover information 152 of the terminal C (S720). Thereafter, the terminal A, the terminal B, and the terminal C each end the RC app and the HTTP server as necessary (S721 to S723).

The above acquisition processing (S714 to S720) of the takeover information 152 by transmission and reception of HTTP requests and HTTP responses is periodically repeated performed. Here, “periodically” means a necessary and sufficient time interval for sharing or updating the takeover information 152, taking into consideration battery drain or congestion with another communication such as telephone incoming call of the mobile terminal 10.

It is noted that if the terminal B and the terminal C whose states are to be continued each have not activated the RC app and the HTTP server, such terminals may not return an HTTP response to an HTTP request received from the terminal A.

### 3. Takeover Processing of Terminal

Next, a process of the mobile terminal 10 taking over the operation of a takeover permission terminal, i.e., another mobile terminal 10x registered as a takeover target in the takeover permission terminal information 154 of the takeover information 152, will be described.

FIG. 8 is a flowchart showing a process of the mobile terminal 10 according to the first embodiment taking over the operation of a takeover permission terminal registered as a takeover target in the takeover permission terminal information 154.

The mobile terminal 10 periodically confirms the state of a takeover permission terminal registered in the takeover permission terminal information 154 (S801). At this time, the mobile terminal 10 determines whether or not a specific event such as telephone incoming call or communication trouble (e.g., power-off due to battery level reduction, disconnection from the local area network 40, etc.) has occurred on the takeover permission terminal (S802). If the mobile terminal 10 has determined that a specific event has occurred on the takeover permission terminal, the mobile terminal 10 confirms whether or not the mobile terminal 10 is registered in the takeover side terminal information 153 of the takeover permission terminal (S803). Then, if the mobile terminal 10 is registered, the mobile terminal 10 takes over the operation of the takeover permission terminal (S804). On the other hand, if a specific event does not occur on the takeover permission terminal or if the mobile terminal 10 is not registered in the takeover side terminal information 153 of the takeover permission terminal though a specific event has occurred on the takeover permission terminal, the mobile terminal 10 returns to step S801 to periodically confirm the state of a takeover permission terminal registered in the takeover permission terminal information 154.

FIG. 9 is a sequence diagram showing a specific process example in the case where the terminal B takes over the operation of the terminal A when a telephone incoming call as a specific event has occurred on the terminal A. In FIG. 9, it will be assumed that the terminal A and the terminal B both have activated the RC app and the HTTP server.

When a telephone incoming call is started (detected), the terminal A prompts the user A to respond to the incoming call (S911, S912), and writes information (flag or the like) indicating being in a call, in the call function of the self terminal information 151 (S913). The terminal S recognizes the telephone incoming call that has occurred on the terminal A, by the periodic state confirmation processing described in FIG. 7 (S914 to S917). Then, the terminal B updates its takeover information 152 to the latest one, and takes over the operation of the terminal A (S919). The user B is notified of completion of the takeover, via screen display on the terminal B (S922, S923). Also, the terminal A updates its takeover information 152 to the latest one (S918), and notifies the user A that the operation has been taken over by the terminal B, via screen display on the terminal A (S920, S921).

FIG. 10 is a sequence diagram showing a specific process example in the case where, when the event (telephone incoming call and talking) that occurred on the terminal A shown in FIG. 9 has finished, the operation taken over by the terminal B is returned to the terminal A. In FIG. 10, it will be assumed that the terminal A and the terminal B both have activated the RC app and the HTTP server.

When the terminal A has detected that the telephone incoming call has finished (S1011) or that the user A has finished talking (S1012), the terminal A writes information (flag or the like) indicating not being in a call, in the call function of the self terminal information 151 (S1013). The terminal B recognizes that the incoming call or talking has finished on the terminal A, by the periodic state confirmation processing described in FIG. 7 (S1014 to S1017). Then, the terminal B updates its takeover information 152 to the latest one, and performs takeover dissolution processing of returning the operation of the terminal A that has been taken over (S1019). The user B is notified of completion of the takeover dissolution, via screen display on the terminal B (S1022, S1023). Also, the terminal A updates its takeover information 152 to the latest one (S1018), and notifies the user A that the operation taken over by the terminal B has returned to the terminal A, via screen display on the terminal A (S1020, S1021).

FIG. 11 is a sequence diagram showing a specific process example in the case where, when power-off or transfer to the outside of the network as a specific event has occurred on the terminal A, the terminal B takes over the operation of the terminal A. In FIG. 11, it will be assumed that the terminal A and the terminal B both have activated the RC app and the HTTP server.

In the state where the RC app is activated, for example, if unintended power-off has occurred owing to battery reduction or the like, or if the terminal A has transferred to the outside of the local area network 40 (S1111), the terminal A loses a function to communicate with the terminal B. The terminal B recognizes occurrence of the event (power-off, transfer to the outside of the network, or the like) on the terminal A, by the periodic state confirmation processing described in FIG. 7 (S1112 to S1114). In this case, since the terminal B cannot acquire the latest information from the terminal A, the terminal B takes over the operation of the terminal A, based on information written in the takeover information 152 of the terminal B in the previous state confirmation processing (S1115). The user B is notified of completion of the takeover, via screen display on the terminal B (S1116, S1117).

FIG. 12 is a sequence diagram showing a specific process example in the case where, when the terminal A has returned or recovered from the event (power-off, transfer to the outside of the network, or the like) that occurred on the terminal A shown in FIG. 11, the operation taken over by the terminal B is returned to the terminal A.

If the terminal A is powered on by battery recovery or the like or if the terminal A has returned to the local area network 40 (S1211), the terminal A activates the RC app and the HTTP server to acquire a function to communicate with the terminal B (S1212). The terminal B recognizes that the terminal A has returned or recovered from the event that has occurred on the terminal A, by the periodic state confirmation processing described in FIG. 7 (S1213 to S1216). Then, the terminal B updates its takeover information 152 to the latest one, and performs takeover dissolution processing of returning the operation of the terminal A that has been taken over (S1217). The user B is notified of completion of the takeover dissolution, via screen display on the terminal B (S1218, S1219).

As described above, in a mobile terminal and a control method for an electronic apparatus using the mobile terminal according to the first embodiment of the present invention, takeover side terminals to take over operations are registered in advance among a plurality of mobile terminals connected in a local area network of an electronic apparatus control system, and each mobile terminal confirms and shares the states of mobile terminals other than the mobile terminal at any time.

Thus, even if the state of a specific mobile terminal has changed so that it has become difficult to continue the operation for the electronic apparatus, the operation that has been performed by the specific mobile terminal can be taken over by a takeover side terminal that is registered in advance.

In addition, resume control can be easily realized by returning the operation taken over by the takeover side terminal to the specific mobile terminal.

It is noted that control may be performed such that it can be confirmed from the outside that the operation of a specific mobile terminal has been taken over by a takeover side terminal. For example, it is conceivable that the brightness of a screen area of the electronic apparatus that the specific mobile terminal uses or that the corresponding sound level is decreased. Such control may he performed continuously while the operation is taken over, or may he performed only when the operation has not been performed for a certain time period.

In addition, in the case where such a specific event as described above does not include power-off due to battery drain, the component of power supply management section 13 may be omitted.

### Second Embodiment

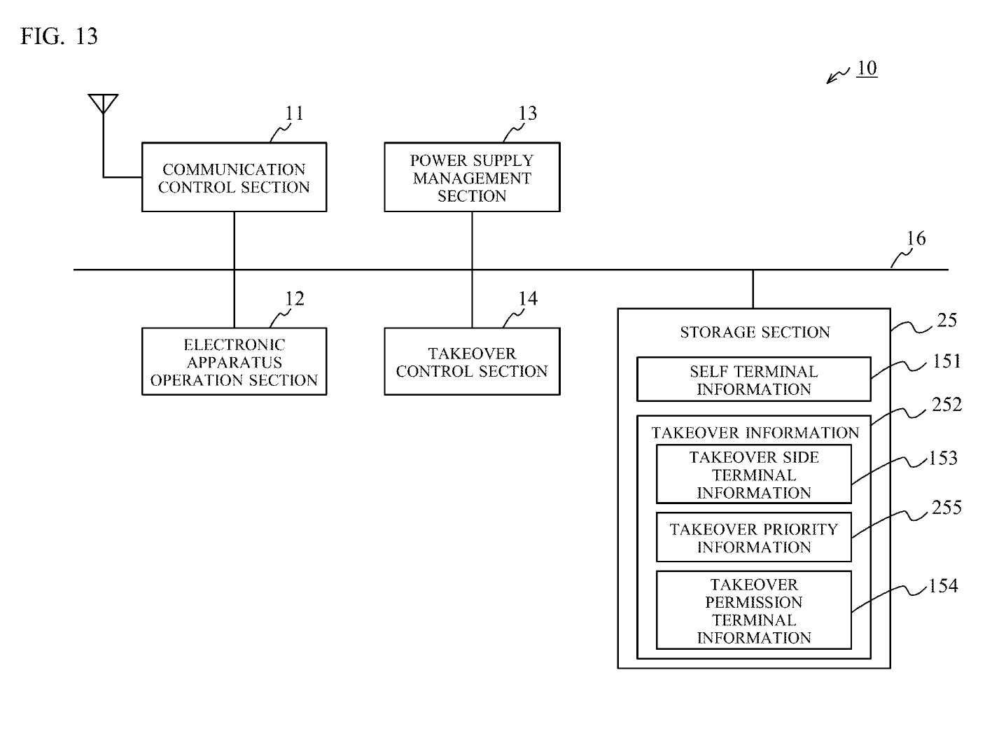

FIG. 13 is a diagram showing the configuration of the mobile terminal 10 according to the second embodiment of the present invention. The mobile terminal 10 according to the second embodiment shown in FIG. 13 includes the communication control section 11, the electronic apparatus operation section 12, the power supply management section 13, the takeover control section 14, and a storage section 25.

The storage section 25 is, for example, a memory and stores the self terminal information 151 which is information about the mobile terminal 10 that the storage section 25 belongs to, and takeover information 252 about another mobile terminal 10x determined by the takeover control section 14. The takeover information 252 is composed of the takeover side terminal information 153, the takeover permission terminal information 154, and takeover priority information 255

The mobile terminal 10 according to the second embodiment is different from the mobile terminal 10 according to the first embodiment in that the storage section 25 includes the takeover priority information 255. The other constituent elements of the second embodiment are the same as those already described in the first embodiment. Therefore, such elements are denoted by the same reference numerals, and the description thereof is omitted.

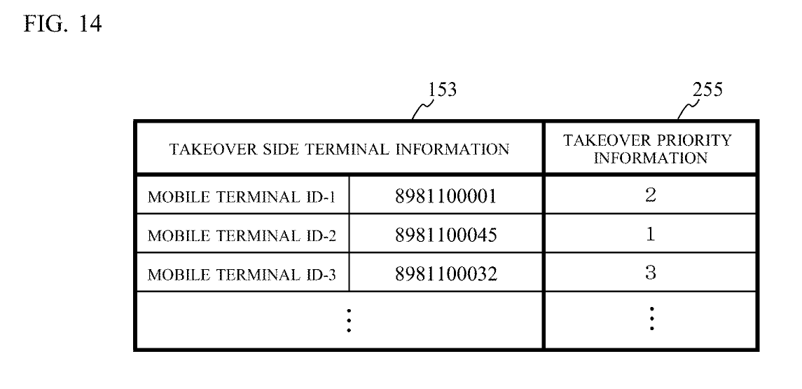

FIG. 14 is a diagram showing an example of the takeover side terminal information 153 and the takeover priority information 255 stored in the storage section 25 of the second embodiment.

The takeover side terminal information 153 includes a mobile terminal ID for uniquely specifying a takeover side terminal as described above. In the second embodiment, a plurality of mobile terminal IDs are registered in the takeover side terminal information 153. The takeover priority information 255 includes priorities for takeover side terminals registered as takeover targets in the takeover side terminal information 153 to take over the operation of the mobile terminal 10 when an event occurs. In an example shown in FIG. 14, the highest priority “1” is written for a takeover side terminal of a mobile terminal ID “8981100045”, the next priority “2” is written for a takeover side terminal of a mobile terminal ID “8981100001”, and the further next priority “3” is written for a takeover side terminal of a mobile terminal ID “8981100032”.

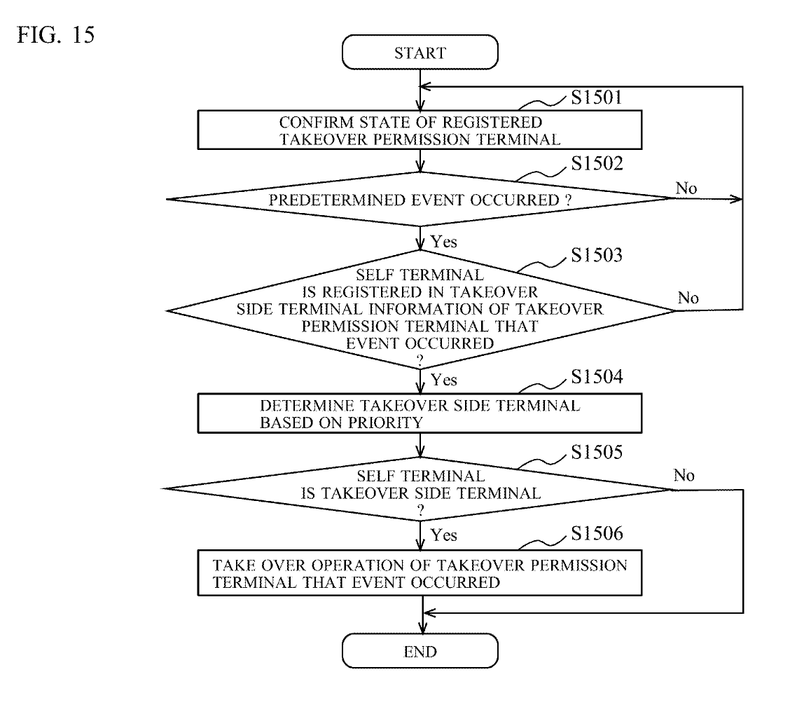

FIG. 15 is a flowchart showing a process of the mobile terminal 10 according to the second embodiment taking over the operation of a takeover permission terminal registered as a takeover target in the takeover permission terminal information 154.

The mobile terminal 10 periodically confirms the state of a takeover permission terminal registered in the takeover permission terminal information 154 (S1501). At this time, the mobile terminal 10 determines whether or not a specific event (telephone incoming call, communication trouble, or the like) has occurred on the takeover permission terminal (S1502). If the mobile terminal 10 has determined that a specific event has occurred on the takeover permission terminal, the mobile terminal 10 confirms whether or not the mobile terminal 10 is registered in the takeover side terminal information 153 of the takeover permission terminal (S1503). If the mobile terminal 10 is registered, the mobile terminal 10 refers to the takeover priority information 255 of the takeover permission terminal, to determine a takeover side terminal that is to take over the operation of the takeover permission terminal where the event has occurred, that is, the takeover side terminal having the highest priority (S1504). Then, if the takeover side terminal having the highest priority is the mobile terminal 10 (S1505: Yes), the mobile terminal 10 takes over the operation of the takeover permission terminal where the event has occurred (S1506), and if the takeover side terminal that can take over the operation and has the highest priority is not the mobile terminal 10 (S1505: No), the mobile terminal 10 ends the takeover processing. It is noted that if any specific event does not occur on the takeover permission terminal, or if the mobile terminal 10 is not registered in the takeover side terminal information 153 of the takeover permission terminal through a specific event has occurred on the takeover permission terminal the process returns to step S1501 to periodically confirm the state of a takeover permission terminal registered in the takeover permission terminal information 154.

As described above, in a mobile terminal and a control method for an electronic apparatus using the mobile terminal according to the second embodiment of the present invention, priorities for execution of takeover operation are assigned to takeover side terminals registered as takeover targets in the takeover side terminal information.

Thus, even if the state of a specific mobile terminal has changed so that it has become difficult to continue the operation for the electronic apparatus, the operation that has been performed by the specific mobile terminal can be taken over by one of a plurality of takeover side terminals that are registered in advance.

It is noted that if a terminal to take over the operation is specified by using takeover priority information, child locking function such as age restriction can be realized.

### Third Embodiment

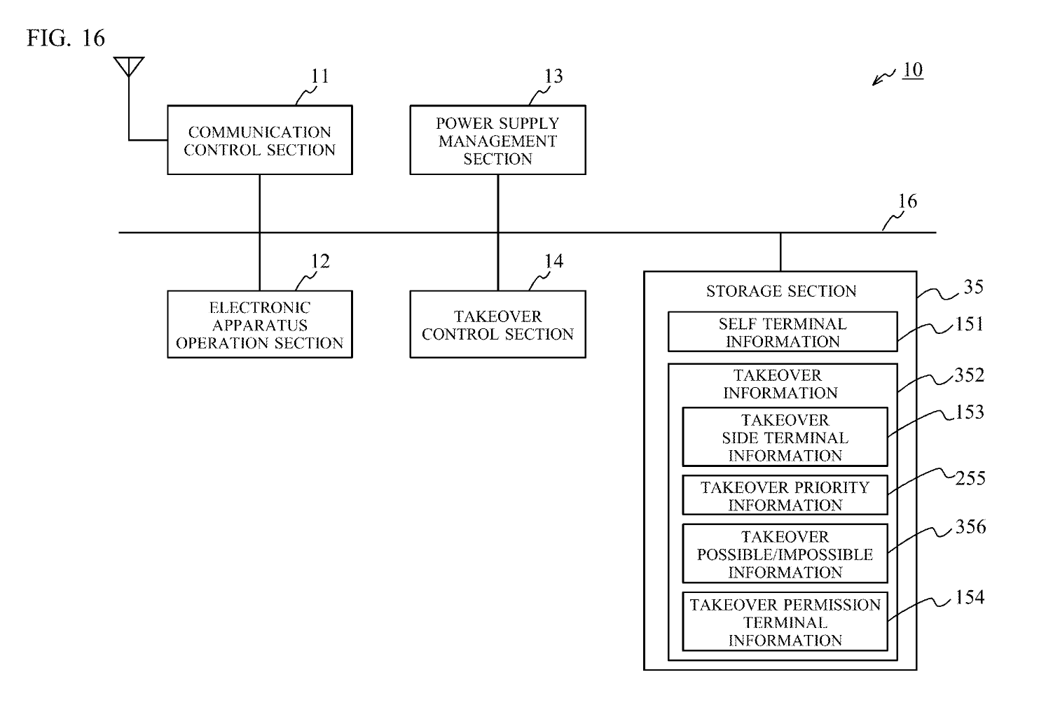

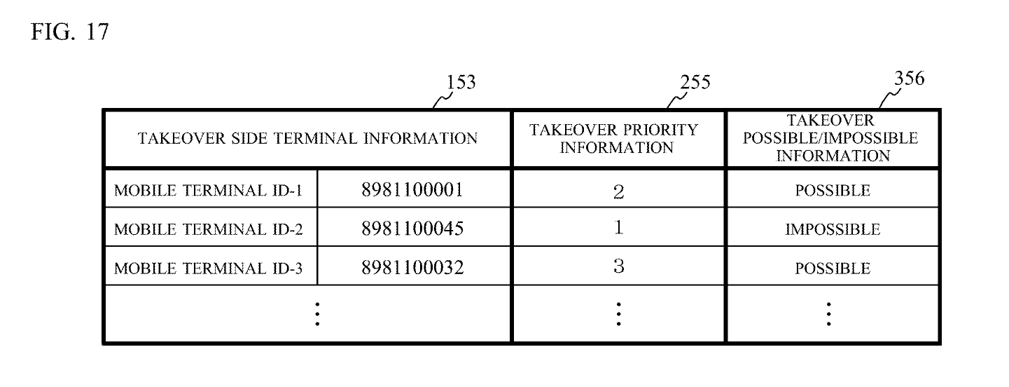

FIG. 16 is a diagram showing the configuration of the mobile terminal 10 according to the third embodiment of the present invention. The mobile terminal 10 according to the third embodiment shown in FIG. 16 includes the communication control section 11, the electronic apparatus operation section 12, the power supply management section 13, the takeover control section 14, and a storage section 35.

The storage section 35 is, for example, a memory, and stores the self terminal information 151 which is information about the mobile terminal 10 that the storage section 35 belongs to, and takeover information 352 about another mobile terminal 10x determined by the takeover control section 14. The takeover information 352 is composed of the takeover side terminal information 153, the takeover permission terminal information 154, the takeover priority information 255, and takeover possible/impossible information 356.

The mobile terminal 10 according to the third embodiment is different from the mobile terminal 10 according to the second embodiment in that the storage section 35 includes the takeover possible/impossible information 356. The other constituent elements of the third embodiment are the same as those already described in the first and second embodiments. Therefore, such elements are denoted by the same reference numerals, and the description thereof is omitted.

FIG. 17 is a diagram showing an example of the takeover side terminal information 153, the takeover priority information 255, and the takeover possible/impossible information 356 stored in the storage section 35 of the third embodiment.

The takeover side terminal information 153 includes a mobile terminal ID for uniquely specifying a takeover side terminal as described above. In the third embodiment, a plurality of mobile terminal IDs are registered in the takeover side terminal information 153. The takeover priority information 255 includes priorities tor takeover side terminals registered as takeover targets in the takeover side terminal information 153, as described above. The takeover possible/impossible information 356 includes information indicating whether or not the takeover side terminals registered in the takeover side terminal information 153 can take over the operation of the mobile terminal 10 when an event occurs. The takeover possible/impossible information 356 is used for such a case that registration as a takeover side terminal has been permitted when the takeover information 352 has been constructed but the takeover side terminal cannot take over the operation at present. An example shown in FIG. 17 indicates that takeover side terminals of mobile terminal IDs “8981100001” and “8981100032” can take over the operation but a takeover side terminal of a mobile terminal ID “8981100045” cannot take over the operation.

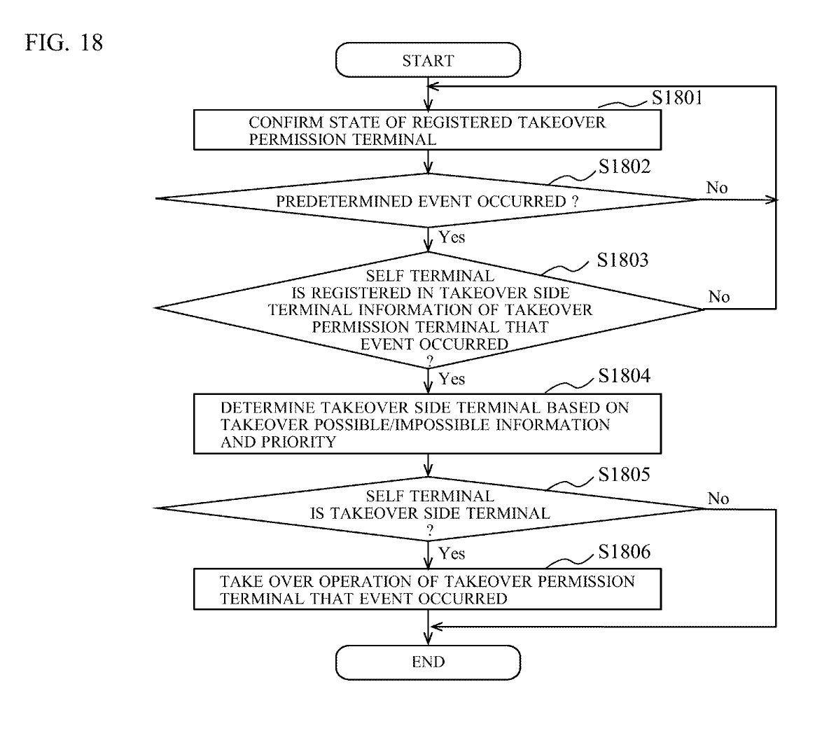

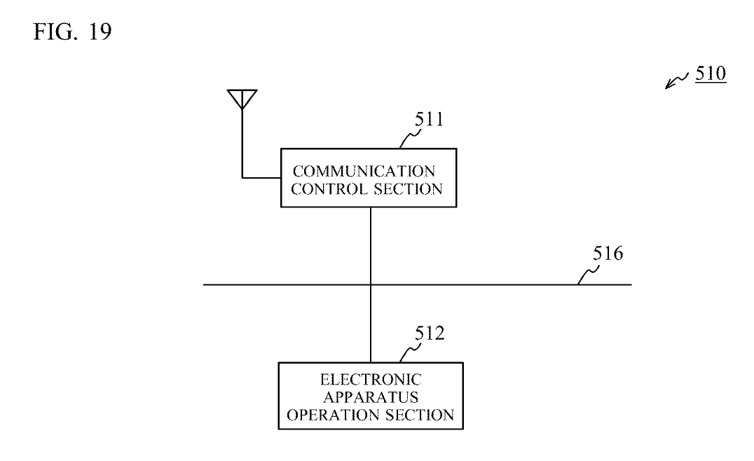

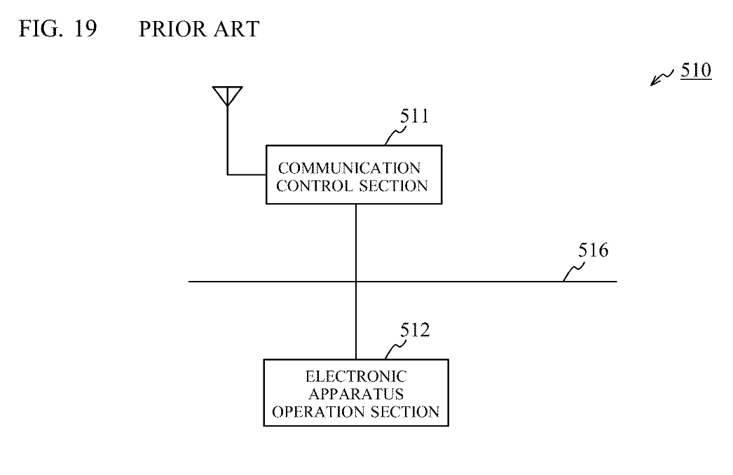

FIG. 18 is a flowchart showing a process of the mobile terminal 10 according to the third embodiment taking over the operation of a takeover permission terminal registered as a takeover target in the takeover permission terminal information 154.

The mobile terminal 10 periodically confirms the state of a takeover permission terminal registered in the takeover permission terminal information 154 (S1801). At this time, the mobile terminal 10 determines whether or not a specific event (telephone incoming call, communication trouble, or the like) has occurred on the takeover permission terminal (S1802). If the mobile terminal 10 has determined that a specific event has occurred on the takeover permission terminal, the mobile terminal 10 confirms whether or not the mobile terminal 10 is registered in the takeover side terminal information 153 of the takeover permission terminal (S1803). If the mobile terminal 10 is registered, the mobile terminal 10 refers to the takeover priority information 255 and the takeover possible/impossible information 356 of the takeover permission terminal, to determine a takeover side terminal that is to take over the operation of the takeover permission terminal where the event has occurred, that is, the takeover side terminal having the highest priority, of the takeover side terminals that can take over the operation (S1804). Then, if the takeover side terminal that can take over the operation and has the highest priority is the mobile terminal 10 (S1805: Yes), the mobile terminal 10 takes over the operation of the takeover permission terminal where the event has occurred (S1806), and if the takeover side terminal that can take over the operation and has the highest priority is not the mobile terminal 10 (S1805: No), the mobile terminal 10 ends the takeover processing. It is noted that if any specific event does not occur on the takeover permission terminal, or if the mobile terminal 10 is not registered in the takeover side terminal information 153 of the takeover permission terminal through a specific event has occurred on the takeover permission terminal, the process returns to step S1501 to periodically confirm the state of a takeover permission terminal registered in the takeover permission terminal information 154.

As described above, in a mobile terminal and a control method for an electronic apparatus using the mobile terminal according to the third embodiment of the present invention, information indicating whether or not the operation can be taken over, and priorities for execution of takeover operation are assigned to takeover side terminals registered in the takeover side terminal information.

Thus, even if the state of a specific mobile terminal has changed so that it has become difficult to continue the operation for the electronic apparatus, the operation that has been performed by the specific mobile terminal can be taken over by one of a plurality of takeover side terminals that are registered in advance.

It is noted that another mobile terminal 10x for which the takeover possible/impossible information 356 of the mobile terminal 10 indicates “impossible” does not take over the operation of the mobile terminal 10. Therefore, the other mobile terminal 10x can omit the processing (FIG. 7) of continuing the terminal state for the mobile terminal 10 that has been notified that the operation cannot be taken over.

In addition, in the above third embodiment, the takeover information 352 uses the takeover priority information 255 and the takeover possible/impossible information 356 in a combined manner, but only the takeover possible/impossible information 356 may be used.

The configurations described in the above embodiments are realized by dedicated hardware or by execution of a program for realizing such configurations by software. The configurations can be realized by a program execution section such as a central processing unit (CPU) reading, interpreting, and executing a software program stored in a storage medium. The storage medium refers to storage mediums including a semiconductor memory such as a ROM, a RAM, or a flash memory, a magnetic disk memory such as a flexible disk or a hard disk, an optical disc memory such as a CD-ROM, a DVD, or a BD, and a memory card. In addition, the storage medium also has a concept including a communication medium such as a telephone line or a transmission path.

Here, software that realizes the mobile terminal of the above embodiments includes the following program. That is, the program causes a computer of the mobile terminal to perform wireless communication with another mobile terminal, stores and shares takeover information having registered therein a takeover target for the operation for an electronic apparatus, monitors the state of a mobile terminal registered as a takeover target in the takeover information, and when a specific event has occurred on a first mobile terminal of a plurality of mobile terminals, causes a second mobile terminal that has registered the first mobile terminal as a takeover target, to take over the operation that the first mobile terminal has performed for the electronic apparatus.

In addition, each component of the mobile terminal of the above embodiments may be implemented as an IC (also referred to as an LSI, a system LSI, a super LSI, an ultra LSI, or the like), which is an integrated circuit. Each component may be separately made as a chip, or some or all of them may be included in one chip. Further, the method of integration is not limited to IC, and may be realized by a dedicated circuit or a general-purpose processor. An FPGA (Field Programmable Gate Array), which is an IC that can be programmed after manufacture, or a reconfigurable processor capable of reconfiguring the connections and the settings of the circuit cells in the IC may also be used.

### INDUSTRIAL APPLICABILITY

The present invention is applicable to a system or the like that includes a plurality of mobile terminals connected in a network and having a function of controlling an electronic apparatus, and particularly, is suitable to such a case where, when the state of a given mobile terminal has changed so that it has become difficult to continue the operation for the electronic apparatus, the operation that has been performed for the electronic apparatus by the given mobile terminal is desired to be taken over by another mobile terminal.

### DESCRIPTION OF THE REFERENCE CHARACTERS

1 electronic apparatus control system

10 mobile terminal

11 communication control section

12 electronic apparatus operation section

13 power supply management section

14 takeover control section

15, 25, 35 storage section

16 bus

20 control signal

30 electronic apparatus

40 network

151 self terminal information

152, 252, 352 takeover in forma lion

153 takeover side terminal information

154 takeover permission terminal information

255 takeover priority information

356 takeover possible/impossible information

1. A mobile terminal in a system mat includes a plurality of mobile terminals connected in a network and performing different operations for the same electronic apparatus, the mobile terminal comprising:
a communication control section configured to control wireless communication with another mobile terminal other than the mobile terminal, and with the electronic apparatus;
an electronic apparatus operation section configured to operate the electronic apparatus via the communication control section;
a storage section configured to store takeover information about the other mobile terminals, the takeover information having registered therein a takeover target for the operation for the electronic apparatus; and
a takeover side control section configured to monitor the state of another mobile terminal registered as the takeover target in the takeover information, and take over, from another mobile terminal for which it has been determined that a specific event has occurred, an operation that the other mobile terminal has performed for the electronic apparatus.

2. The mobile terminal according to claim 1, wherein the takeover side control section, by periodically communicating with another mobile terminal registered as the takeover target in the takeover information, shares the states of the mobile terminals and the takeover information, with the other mobile terminal.

3. The mobile terminal according to claim 1, wherein a plurality of other mobile terminals registered as the takeover targets are stored together with priorities, in the takeover information, and
the takeover side control section, when the priority of the mobile terminal is the highest, takes over, from another mobile terminal for which it has been determined that a specific event has occurred, an operation that the other mobile terminal has performed for the electronic apparatus.

4. The mobile terminal according to claim 1, wherein a plurality of other mobile terminals registered as the takeover targets are stored together with priorities and information indicating whether or not the plurality of other mobile terminals can take over, in the takeover information, and
the takeover side control section, when the priority of the mobile terminal is the highest among the mobile terminals that can take over, takes over, from another mobile terminal for which it has been determined that a specific event has occurred, an operation that the other mobile terminal has performed for the electronic apparatus.

5. The mobile terminal according to claim 1, wherein the specific event is at least one of telephone incoming call and transfer to the outside of the network.

6. The mobile terminal according to claim 5, further comprising a power supply management section configured to manage a power supply state, wherein
the specific event also includes power-off.

7. A control method for an electronic apparatus operation using a mobile terminal in a system that includes a plurality of mobile terminals connected in a network and performing different operations for the same electronic apparatus, the control method comprising the steps of:
performing wireless communication among the plurality of mobile terminals, and storing and sharing takeover information having registered therein a takeover target for the operation for the electronic apparatus;
causing each of the plurality of mobile terminals to monitor the state of a mobile terminal registered as the takeover target in the takeover information; and
causing, when a specific event has occurred on a first mobile terminal of the plurality of mobile terminals, a second mobile terminal that has registered the first mobile terminal as a takeover target, to take over the operation that the first mobile terminal has performed for the electronic apparatus.
